(19) United States
(12) Patent Application Publication
(10) Pub. No.: US 2007/0181046 A1
(43) Pub. Date: Aug. 9, 2007

(54) Locking vault and its method of installation

(76) Inventors: Bonnie J. Hanson, Racine, WI (US); Steven P. Hanson, Racine, WI (US); Joshua J. Hanson, Racine, WI (US); Graham P. Hanson, Racine, WI (US)

Correspondence Address: JANSSON SHUPE & MUNGER LTD., 245 MAIN STREET, RACINE, WI, 53403, US

(21) Appl. No.: 11/349,299

(22) Filed: Feb. 7, 2006

(51) Int. Cl. E05G 1/00

(52) U.S. Cl. 109/48

(57) ABSTRACT

A locking vault is adapted to be installed adjacent to at least one housing joist having a longitudinal axis, and includes a pivot having a longitudinal axis essentially orthogonal with respect to the longitudinal axis of the housing joist, a first box adapted to swing, between an open position and a locked position, about the pivot at a pivoting end thereof, the first box having two lengthwise sides and two opposite lengthwise ends that consist of the pivoting end and a locking end, and a lock disposed proximate the locking end and having an extendable locking pin dimensioned to extend at least from one of the lengthwise sides through the adjacent housing joist.

### FIELD OF THE INVENTION

The invention relates generally to concealed storage and, more particularly, to a storage vault adapted for being concealed as an apparently integral part of a house or other building.

### BACKGROUND

Storage devices have been used for making use of otherwise unused space in a house or other structure. For example, closet organizers and the like may simply improve the efficiency of storage within a given space, and access doors and shelving may be installed for storage under stairwells, in attics, etc. It is known to use for storage the space between exposed rafters in basements or elsewhere. Conventional storage devices may be difficult to install, may not be adapted for concealment, may have complicated mechanisms for opening or accessing a storage compartment, may have inadequate or cumbersome locking mechanisms, may have an excess weight, or have other related problems.

### OBJECTS OF THE INVENTION

It is an object of the invention to provide an improved locking vault overcoming some of the problems and shortcomings of the prior art, including those referred to above.

Another object of the invention is to provide a locking vault adapted to be concealed as a part of duct work or similar construction of a ceiling.

Another object of the invention is to provide a locking vault that may be installed to be out of reach of children.

Still another object of the invention is to provide a locking vault having a simple construction, simple installation, and simple locking mechanism.

Yet another object of the invention is to provide a locking vault adaptable to have a long dimension while maintaining a light weight.

Another object of the invention is to provide a locking vault adapted for installation between adjacent building studs and adapted for personalizing the interior and/or exterior thereof.

How these and other objects are accomplished will become apparent from the following descriptions and the drawings.

### SUMMARY

According to an aspect of the invention, a locking vault adapted to be installed adjacent to at least one housing joist having a longitudinal axis, includes a pivot having a longitudinal axis essentially orthogonal with respect to the longitudinal axis of the housing joist, a first box adapted to swing, between an open position and a locked position, about the pivot at a pivoting end thereof, the first box having two lengthwise sides and two opposite lengthwise ends that consist of the pivoting end and a locking end, and a lock disposed at the locking end and having an extendable locking pin dimensioned to extend at least from one of the lengthwise sides through the housing joist.

According to another aspect of the invention, a method of installing a locking vault in a building having at least one housing joist with a longitudinal axis includes providing a pivot having a longitudinal axis essentially orthogonal with respect to the longitudinal axis of the housing joist, providing a box adapted to swing, between an open position and a locked position, about the pivot at a pivoting end thereof, the box having two lengthwise sides and two opposite lengthwise ends that consist of the pivoting end and a locking end, and providing a lock disposed at the locking end and having an extendable locking pin dimensioned to extend at least from one of the lengthwise sides through the housing joist.

According to another aspect of the invention, an installation method may include drilling a hole in the housing joist for receiving the locking pin.

As a result of various implementations of the invention, an improved locking vault and method of installation overcome certain problems of the prior art.

The foregoing summary does not limit the invention, which is instead defined by the attached claims.

### BRIEF DESCRIPTION OF THE DRAWING FIGURES

FIGS. 1A-1C respectively show a side, top, and end view of a locking vault according to an exemplary embodiment of the invention.

FIG. 2 is an elevation view of a bolt plate used for various parts of an exemplary structure and installation of a locking vault, such as for installing pivoting and/or support structure, for installing a locking pin receptacle, and others.

FIGS. 3A and 3B respectively show an end view and a side view of a bolt standoff used in supporting a vault body in an exemplary embodiment of the invention.

FIG. 4 is a perspective view of a locking vault installed between two adjacent floor joists, according to an exemplary embodiment of the invention.

FIG. 5 is a partial perspective view of an installed locking vault having a side lock and a locking end, according to an exemplary embodiment of the invention.

FIG. 6 is a perspective view of a bolt standoff mounted to a bolt plate using a carriage type bolt, according to an exemplary embodiment of the invention.

FIG. 7 is a perspective view of a lag bolt used for installing a bolt standoff, according to an exemplary embodiment of the invention.

FIG. 8 is a perspective view of a bolt box being used as part of a side lock structure of a locking vault, the bolt box being mounted to an outer side of a joist whose inner side is adjacent the vault body, according to an exemplary embodiment of the invention.

FIG. 9 is a perspective view of an L-bolt used for locking a vault body to a joist through a hole in the joist, according to an exemplary embodiment of the invention.

FIG. 10 is a perspective view of a bolt box being used as part of a side lock structure of a locking vault, the bolt box being similar to that shown in FIG. 8 except that a straight bolt is used for locking a vault through a joist, according to an exemplary embodiment of the invention.

FIG. 11 is a perspective view of a combination dial type locking cover used for providing coded access to the inside of a bolt box being used as part of a side locking system for a locking vault, according to an exemplary embodiment of the invention.

FIG. 12 is a perspective view of a combination push button type locking cover used for providing coded access to the inside of a bolt box being used as part of a side locking system for a locking vault, according to an exemplary embodiment of the invention.

FIG. 13 is a perspective view of the combination push button type locking cover of FIG. 12 installed in a bolt box being used as part of a side locking system for a locking vault, according to an exemplary embodiment of the invention.

FIG. 14 is a perspective view of an end lock having a sliding pin and a key lock, the end lock adapted for mounting to a locking end of a locking vault, according to an exemplary embodiment of the invention.

FIG. 15 is a perspective view of an installer marking a position for drilling a pin-receiving hole in a joist in an installation of an end lock type locking vault, according to an exemplary embodiment of the invention.

FIG. 16 is a partial perspective view of a key type end lock of a locking vault in an unlocked and hanging position, according to an exemplary embodiment of the invention.

FIG. 17 is a partial perspective view of the locking vault of FIG. 16 in an up and locked condition.

FIG. 18 is a perspective view of a sliding cross rail installed laterally across an open side of a locking vault and connected at its ends to lengthwise flanges of the vault body, according to an exemplary embodiment of the invention.

FIG. 19 is a partial perspective view of one end of the sliding cross rail of FIG. 18, showing sliding connection of such rail to a lengthwise flange.

FIG. 20 is a perspective view of a locking hasp adapted for use as an end lock of a locking vault, according to an exemplary embodiment of the invention.

FIG. 21 is a perspective view of a bracket adaptable for use as a ceiling mount hanger for supporting a vault body, or for being mounted to receive a locking pin of an end lock of a locking vault, according to an exemplary embodiment of the invention.

FIG. 22 is a partial perspective view of an alternative type vault and vault mounting mechanism, according to an exemplary embodiment of the invention.

FIG. 23 is a perspective view of a bracket adapted for use as an alternative structure for securing a vault body to a joist, according to an exemplary embodiment of the invention.

### DETAILED DESCRIPTION OF PREFERRED EMBODIMENTS

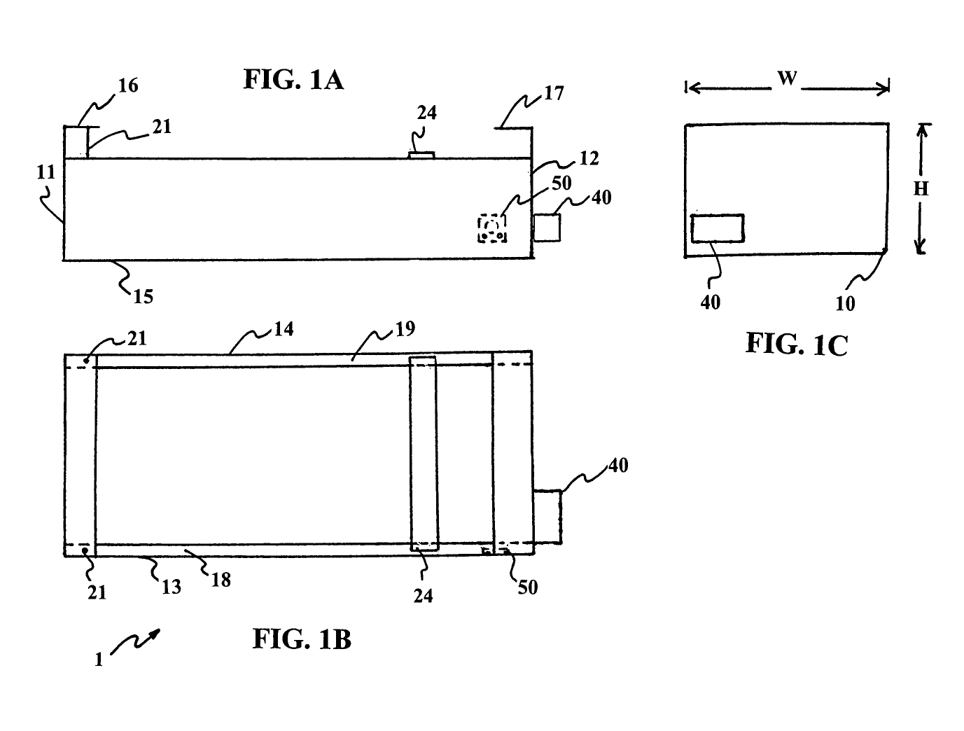

FIGS. 1A-1C respectively schematically show front, top, and end views of a locking vault 1. Vault 1 is shown therein with alternative locking mechanisms 40 and 50, where either or both locking mechanism types 40, 50 may be used for a vault body 10. Vault body 10 has a pivoting end 11, a locking end 12, a left side 13, a right side 14, a bottom side 15, a first top flange 16, a second top flange 17, a first longitudinal flange 18, and a second longitudinal flange 19. First top flange 16 is rigidly connected at two points, respectively to first and second longitudinal flanges 18, 19, by stop bolts 21. A sliding cross rail 24 attaches at its opposite lengthwise ends to first and second longitudinal flanges 18, 19, and maybe slid along flanges 18, 19 and secured at a chosen location therealong. As shown in FIG. 1C, the width “W” of a vault body 10 may be adapted to be slightly less than a distance between adjacent floor joists in a ceiling, and may be adapted to have a height “H” somewhat less than a distance between the lower edges and upper edges of such joists. In such a case, vault body 10 may, for example, be concealed alongside the joists in the ceiling area. In a preferred embodiment, vault body 10 is formed of galvanized sheet metal of a same type as is used for HVAC ductwork, so that vault body 10 appears to be a part of an HVAC system of the resident building.

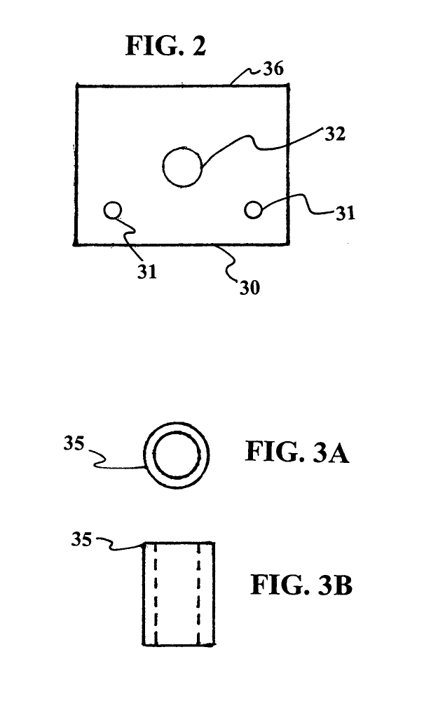

FIG. 2 shows a bolt plate 30 having screw holes 31 and a bolt hole 32. For example, bolt plate 30 may be formed of 0.060 inch steel plate or similar material. FIGS. 3A and 3B respectively show an end view and an elevation view of a bolt standoff 35 formed, for example, as a steel tube with a length of one inch, an outer diameter of ⅝ inch, and an inner diameter of 7/16 inch.

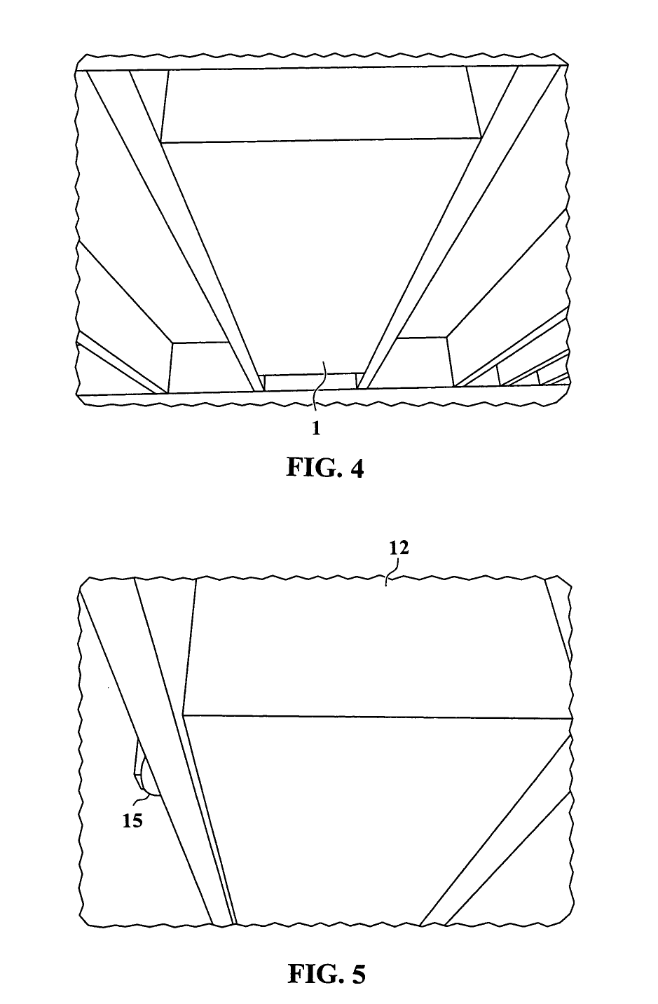

FIG. 4 is a perspective view of locking vault 1 installed between a pair of ceiling joists and in an up and locked position. Locking vault 1 appears to be part of the HVAC ductwork abutting the interior sides of the pair of joists of the resident building, and may in such an example have a vault body 10 formed of the same or similar HVAC ductwork sheet metal as is used for the passage of air. The structure thereby disguises a locking vault as an apparent part of an HVAC air circulation ductwork system. FIG. 5 is a perspective partial view of a locking vault 1 in an up and locked position, with its locking end 12 secured using a side lock 50 having a pin passing through the joist and covered at an external side of the respective joist by a side cover 51.

Vault body 10 is held at its pivoting end 11 by two bolt standoffs 35 abutting an inward-facing side of first top flange 16. Such bolt standoffs 35 are secured to respective ones of the pair ofjoists with bolts and bolt plates 30. Vault body 10 may also be held near its locking end 12 by a second pair of opposed bolt standoffs 35 and accompanying bolt plates 30. For example, a pair of bolt standoffs 35 may be mounted to oppose one another and support vault body 10 at an underside of first top flange 16, and a second pair of bolt standoffs 35 may be mounted to oppose one another and support vault body 10 at an underside of second top flange 17. The bolt assemblies that include bolt plates 30 and bolt standoffs 35 may preferably be independent of vault body 10. Examples of securement of bolt standoffs 35 and bolt plates 30 to joists are now discussed.

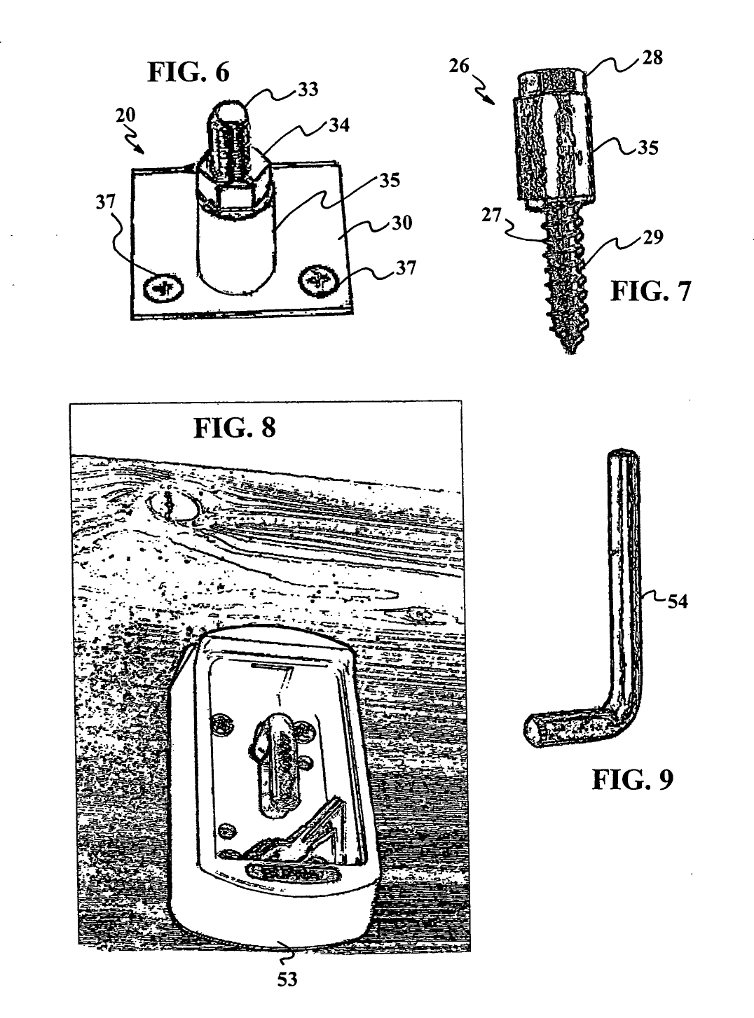

FIG. 6 is a perspective view of a bolt standoff 35 installed with one of its lengthwise ends abutting bolt plate 30. As discussed further below, a hole is drilled in a wooden joist at a position for passing a bolt through the joist and through bolt hole 32 of bolt plate 30. For example, bolt plate 30 may be placed so that its top side 36 is flush with a top of the joist, and the hole through the joist may be marked by using hole plate 30 as a template. A carriage bolt 33 is placed through the hole in the joist so that its smooth and unslotted head (not shown) is the only externally-exposed portion of carriage bolt 33 when locking vault 1 is in the up and locked position shown in FIG. 5. Such a carriage bolt head reduces or prevents unwanted tampering. Carriage bolt 33 is passed through the hole in the joist, through bolt hole 32, through the center hole of bolt standoff 35, and then secured with a nut 34 having threads corresponding to threads of carriage bolt 33. Bolt plate 30 is secured to the vault-side of the joist with wood screws 37 that are screwed into the joist via screw holes 31. The assembly is repeated for an adjacent joist so that like carriage bolt type hanger assemblies 20 face one another between the pair of joists. Such pair of opposed bolt standoffs 35 are also installed to support vault body 10 near locking end 12. Vault body 10 is supported by respective bolt standoffs 35 of the installed assemblies 20, along first top flange 16 and along second top flange 17 when vault 1 is in the up and locked position and along pivoting end 11 when vault 1 is in an unlocked and lowered position. In one example, second top flange 17 has a shorter length compared to first top flange 16, so that second top flange 17 may be horizontally slid over its corresponding pair of bolt standoffs 35 without disengaging first top flange from its pair of bolt standoffs 35. Additional detail is provided below.

FIG. 7 is a perspective view of an alternative structure for mounting a bolt standoff 35 and bolt plate 30 to a joist. In such a case, a lag bolt 27 is placed through bolt standoff 35 and then through bolt plate 30 by screwing lag bolt 27 into the joist. For example, lag bolt 27 has a hexagonal head 28 that may be turned by a socket driver to thereby screw the body 29 of lag bolt 27 into the joist. In such a manner, lag bolts 27 are oriented with their respective heads 28 inside vault body 10 when vault body 10 is installed over bolt standoffs 35 and lag bolt bodies 29 preferably extend only part of the way through the respective joists, so that no part of lag bolts 27 are exposed to the external sides of the pair of joists.

As shown by example in FIG. 5, locking vault 1 may be locked to a joist by use of a mechanism not visible between the pair of joists. In one such example, a side lock 50 has a pin receiving plate that may have a same size and shape as bolt plate 30, although bolt plate 30, when used for mounting bolt standoffs 35, preferably has curved countersinks around screw holes 31 for flush mounting of wood screws 37. However, when plate 30 is used for a pin receiving plate, screw holes 31 are not countersunk and instead receive machine screws for holding the pin receiving plate to leftside 13 of vault body 10 by a use of corresponding nuts and lockwashers (not shown). A hole formed in leftside 13 is in registration with hole 32 of plate 30, the hole in leftside 13 being, for example, a punchout type hole. Side lock 50 is formed by drilling a hole through the adjacent joist to be in registration with the hole of the pin receiving plate when the locking vault is in the up position. A joist-mounted base unit 52 is then mounted to the exterior side of the joist, using wood screws or the like, so that a hole in base unit 52 is in registration with the hole through the joist. An exemplary base unit 52 is available from Supra Products of Salem, Oreg., and is shown in FIG. 8 as a bolt type box 53 with an L-bolt installed through a hole therein, bolt type box 53 shown installed on the external side of a joist. An L-bolt 54 is shown in FIG. 9. When vault body 10 is placed in its up position, L-bolt 54 is placed through the hole in box 53, through the hole in the joist, through the hole in left side 13, and through the hole in the pin receiving plate, thereby locking vault 1 in its up and locked position. Then, a cover is placed onto L-bolt type box 52. Such cover may be locked onto box 52 in a number of ways as described below.

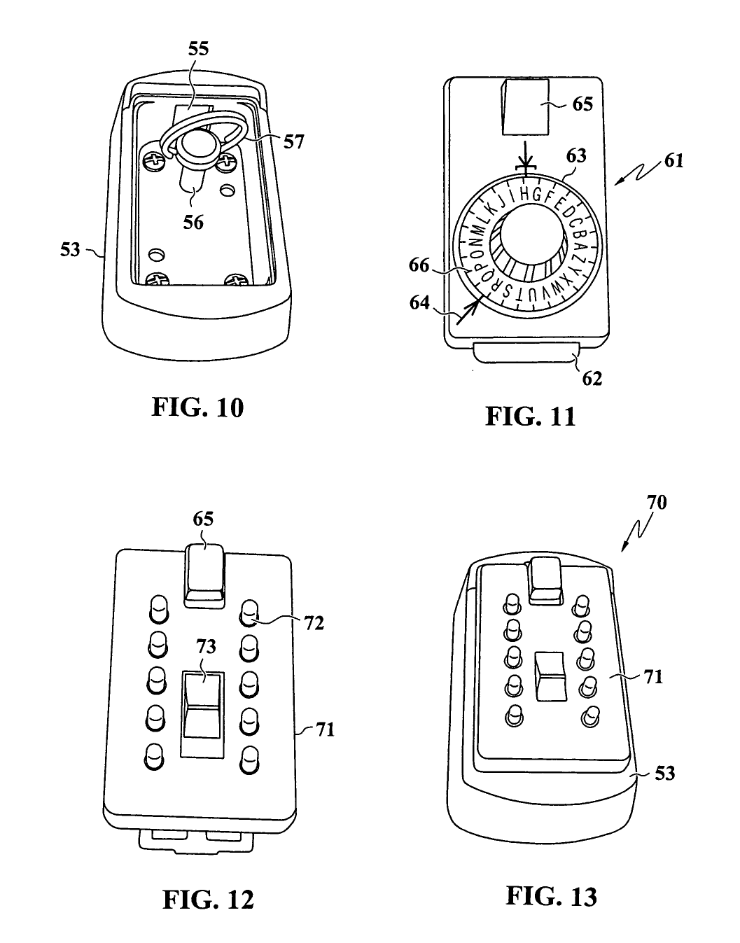

FIG. 10 shows a bolt type box 53 with a straight bolt 56 placed through the hole in box 53. Straight bolt 56 has an attached pull ring 57 for assisting a user in removing bolt 56 in order to unlock locking vault 1, and such an arrangement may be easier to use than the L-bolt assembly shown in FIG. 8. In any such case, an L-bolt 54, straight bolt 56, or similar item may also be referred to herein as a “pin,” provided as part of a locking mechanism.

A cover 51 for concealing a locking pin and preventing access to such locking pin may itself be locked to base 52 in any number of alternative ways. For example, FIG. 11 shows a dial type locking cover 61 adapted to fit into base unit 52, 53 by first inserting a tab 62 into a slot (not shown) in base unit 52, 53 and then snapping a spring-loaded locking member, or detent, (not shown) into a receptacle 55 in base unit 52, 53. The detent is coupled to or a part of a slide button 65. Slide button 65 and the associated detent are in a locked and non-moveable state when a dial combination locking mechanism 63 has its internal tumblers (not shown) in a non-enabling condition. By comparison, when a user enters a correct code by rotating a dial 66 of dial combination lock 63 in a required sequence, the internal tumblers are moved to an enabling state where the detent and associated slide button 65 are able to be moved, which releases the detent from catch 55 of base unit 52, 53 and allows cover 61 to be removed from base unit 52, 53, thereby exposing locking pin 54, 56. The user can enter the correct combination by turning dial 66 in one direction until a prescribed letter or other character of dial 66 is in registration with an indicator mark 64, and then turning dial 66 in the opposite direction until a next character shown on dial 66 is in registration with indicator mark 64, etc., until the entire combination has been entered by rotation in alternating directions in a known manner. Such a combination mechanism and locking box has been commonly used, for example, in lock boxes for securing a house key of a home for sale, for subsequent access by a realtor who knows the combination code.

In another example of a cover 51, FIG. 12 shows a push button type locking cover 71 adapted to fit into base unit 52, 53 by first inserting a tab 62 into a slot (not shown) in base unit 52, 53 and then snapping a spring-loaded locking member, or detent, (not shown) into a receptacle 55 in base unit 52, 53. Push button type locking cover 71 has an array of push buttons 72 each having an adjacent legend or character (not shown) marked on cover 71 next to the respective button 72. A user can enter a sequence of button pushes and, when such a sequence matches a correct code for opening cover 71, an opening switch 73 is then enabled for sliding and releasing button/detent 65, which allows cover 71 to be removed from base unit 53. FIG. 13 shows a push button type assembly 70 having push button type locking cover 71 installed in base unit 53.

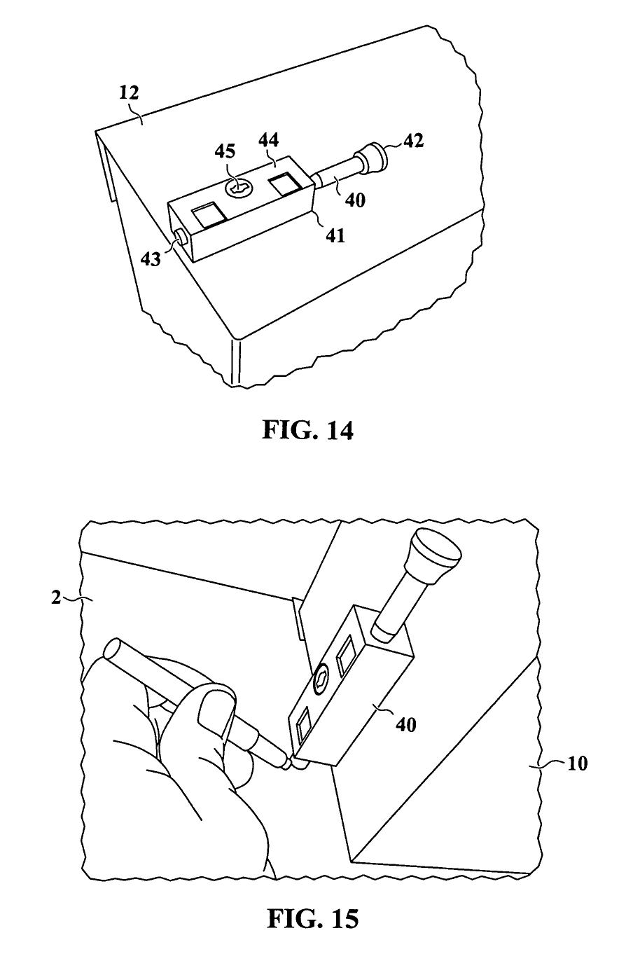

FIG. 14 shows an end lock 40 having a screw-on key lock assembly 44 mounted on the outside wall of locking end 12 of vault body 10, such as by use of screws or bolts (not shown) that pass through holes in locking end 12 and are tightened into receptacles integrally formed with or connected to a surface mount side of key lock assembly 44. A sliding pin 41 is inserted through a bore of key lock assembly 44 so that a distal end 43 of pin 41 is passed completely through key lock assembly 44. A key lock mechanism 45 is disposed as a part of key lock assembly 44 and, when in a locked state, prevents movement of pin 41. An end cap 42 is provided on the side of pin 41 that faces the middle of locking end 12. End cap 42 allows a user to easily grip it for moving pin 41 when key lock mechanism 45 is in an unlocked state. FIG. 15 shows an installation of a hole through a joist 2 by a user who has secured pivoting end 11 and is holding vault body 10 in an up position where second top flange 17 is essentially parallel to or in close proximity to the horizontal top edge of joist 2. The user then marks, e.g., by using a pen, the position for drilling a hole in joist 2 to receive the distal end 43 of pin 41.

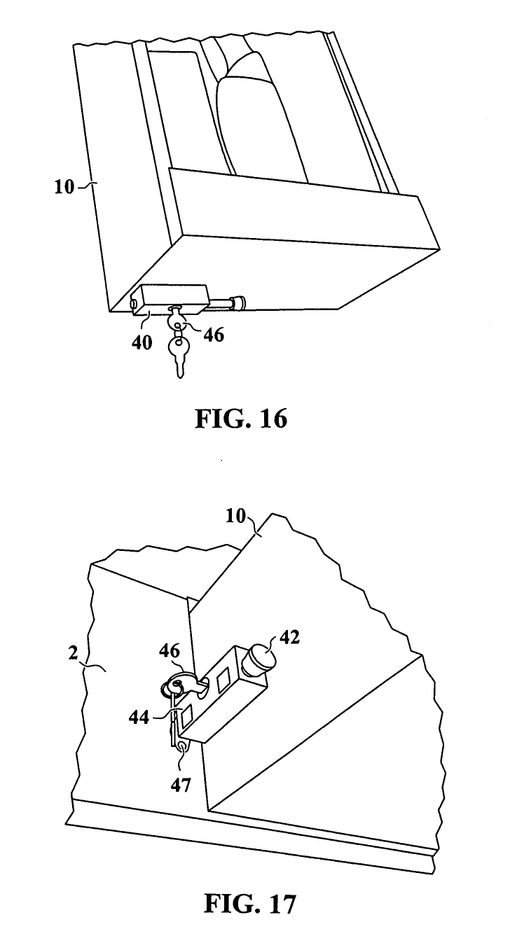

FIG. 16, in partial perspective view, shows locking vault 10 in a lowered and unlocked position. A key 46 is shown inserted in key lock mechanism 45, and pin 41 is slid so that distal end 43 is retracted away from joist 2.

FIG. 17, in partial perspective view, shows vault body 10 in an up and locked position. A hole has been drilled into joist 2 at a position for receiving pin 41. In the example shown, a pin receptacle bracket 47 has been mounted to joist 2. Bracket 47 has a hole (not shown) slightly larger in diameter than pin 41, and is mounted so that such hole is aligned for receiving pin 41 when the user locks vault body 10 to joist 2 by pushing end cap 42, which forces pin 41 into the hole in joist 2. Then, the user locks key lock mechanism 45 by turning key 46, which prevents pin 41 from being moved. For example, pin 41 may have an annular groove (not shown) that is aligned with a locking member (not shown) that is a part of key lock mechanism 45 and that is moved into said annular groove when the key 46 is turned to a locking position. In various other embodiments, an end lock 40 may have a spring-loaded mechanism adapted to urge a pin, when unlocked, toward a retracted position or, alternatively, away from such retracted position, depending on the particular application.

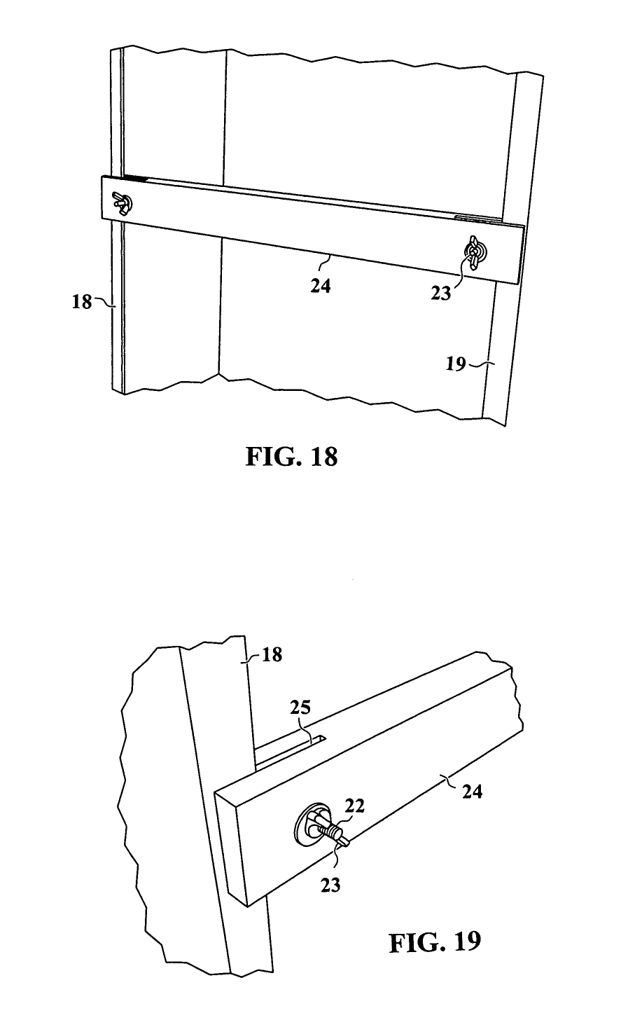

FIG. 18 is a perspective view of a sliding cross rail 24 and FIG. 19 is an enlarged partial perspective view of an end portion thereof. In this example, sliding cross rail 24 is formed of wood and has slots 25 formed at each lengthwise end thereof. Slots 25 receive respective ones of longitudinal flanges 18, 19 of vault body 10. The respective ends of sliding cross rail 24 may be tightened against or loosened from longitudinal flanges by tightening or loosening respective wing nuts 23. Wing nuts 23 are threaded onto respective bolts 22 that are placed into holes through widthwise portions of sliding cross rail 24, the holes traversing respective ones of slots 25. Washers and the like may also be used. When tightened, wing nuts 23 secure sliding cross rail at a chosen longitudinal position and, when loosened, allow cross rail 24 to be slid longitudinally to a different position along longitudinal flanges 18, 19. When tightened, cross rail 24 provides lateral support to the structure of vault housing 10 and also prevents items being stored in vault 1 from falling out when vault 1 is lowered.

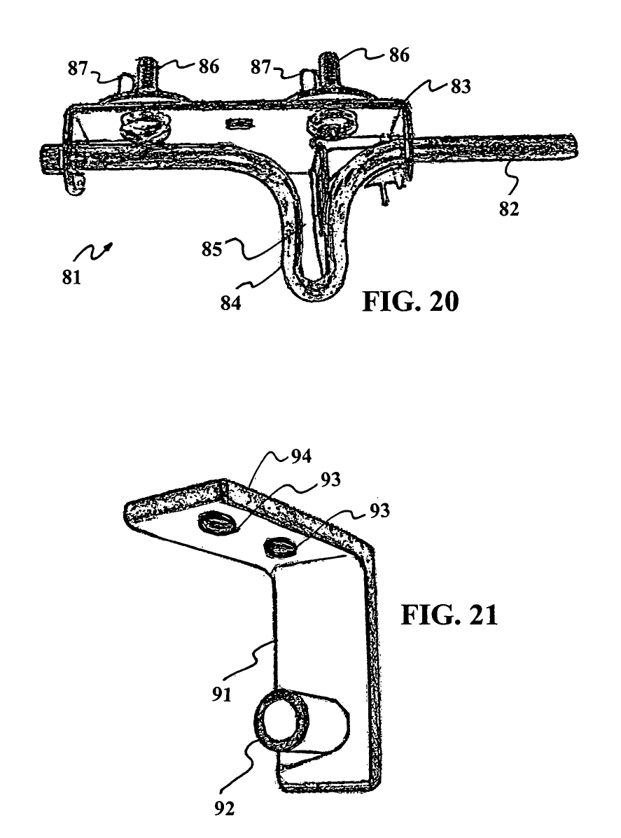

FIG. 20 shows a locking padlock hasp 81 adaptable for use as an endlock 40 in an alternative embodiment. As shown, a pin 82 is extended away from a frame 83. A bend 84 in pin 82 is positioned around a lock receptacle 85, which prevents pin 82 from moving. When a lock such as a padlock is placed through a hole in lock receptacle 85, bend 84 is prevented from being rotated into a sliding position by such padlock. Bolts 86 are used for securely attaching padlock hasp 81 to locking end 12 of vault body 10 via holes formed therein, and keying projections 87 are used for accurate placement of padlock hasp by insertion of such projections 87 into additional holes formed in locking end 12. In the embodiment shown, extended pin 82 may extend from right side 14 of vault body 10. Padlock hasp 81 may alternatively be adapted for placement on left side 13 of vault body 10.

FIG. 21 shows a mounting bracket 91 in a first example being adapted for mounting a standoff 92 in an alternative embodiment where bracket 91 is mounted to a flat ceiling such as the underside of a sheet of flooring mounted to a top side of the joists. Holes 93 are provided on a mounting portion 94 of bracket 91 so that, for example, bracket 91 may be secured to a ceiling or joist with wood screws, lag bolts, or the like. Standoff 92 may be secured to bracket 91, for example, with a flush mount bolt (not shown) and an associated nut and washers (not shown). Mounting bracket 91 in a second example may be used for mounting standoff 92 for receiving pin 82 of locking padlock hasp 81 therein. In such a case, bracket 91 is mounted to adjacent joist 2 so that standoff 92 is centered with pin 82 when vault body 10 is in an up position. For example, standoff 92 may be formed as a cylinder with a center hole at one end of the cylinder being slightly larger than pin 82. By placing such cylinder end in registration with pin 81 when vault body 10 is in an up position, pin 81 may be slid into the center hole of standoff 92, and then a padlock may be locked onto hasp 81 as described above. When bracket 91 is used in such a manner, the other end of standoff 92 may have a threaded hole for receiving a corresponding threaded bolt, thereby securing that end of standoff 92 to bracket 91 prior to mounting bracket 91 on joist 2.

As used herein, a “joist,” “ceiling stud,” or similar expression is not limited to exposed floor joists in a ceiling, but can also refer to rafters, or any frame member commonly used in a residential or commercial building including, for example, wall, ceiling, and floor framework. A “pivoting” and a “pivot end” of a vault may refer to any supporting structure adapted for allowing one end of the vault to be secured, suspended, and/or rotated, either about a single axis or in reference to such an axis. Such a pivoting structure may also be adapted for allowing the vault to slide with or without rotating, such as by sliding horizontally along a space under a ceiling. For example, when an area bounded by pivoting end 11 and first top flange 16, of vault body 10, is formed about a pair of opposed bolt standoffs 35 attached respectively and independently to opposed sides of a pair of adjacent ceiling joists 2, the entire structure or parts thereof may be referred to for convenience as a pivoting structure even though such structure may optionally be used for a sliding movement that does not include any rotation. A preferred embodiment, however, includes both longitudinal sliding of a vault body 10 as well as rotating movement of a vault body 10 between an up and a down vault body position.

FIG. 22 is a partial perspective view of an alternative vault hanger structure that does not include bolt standoffs 35 mounted completely independently of vault body 10. Rather, the FIG. 22 structure has a slider assembly that includes slots 75 formed symmetrically opposite one another on sides 13, 14 of vault body 10. Slots 75 each receive, for example, a carriage bolt 76 fed through a hole in joist 2. A wingnut 77 or other suitable fastener, and washers and the like, are used to loosen vault body 10 for movement or tighten vault body 10 to prevent movement, such as when it desired to secure vault 1 in a lowered and hanging position. Slot 75 allows vault body 10 to be pivoted (e.g., lowering or raising of locking end 12) or slid such as when vault body 10 is in an up position prior to locking of vault 1 to joist 2.

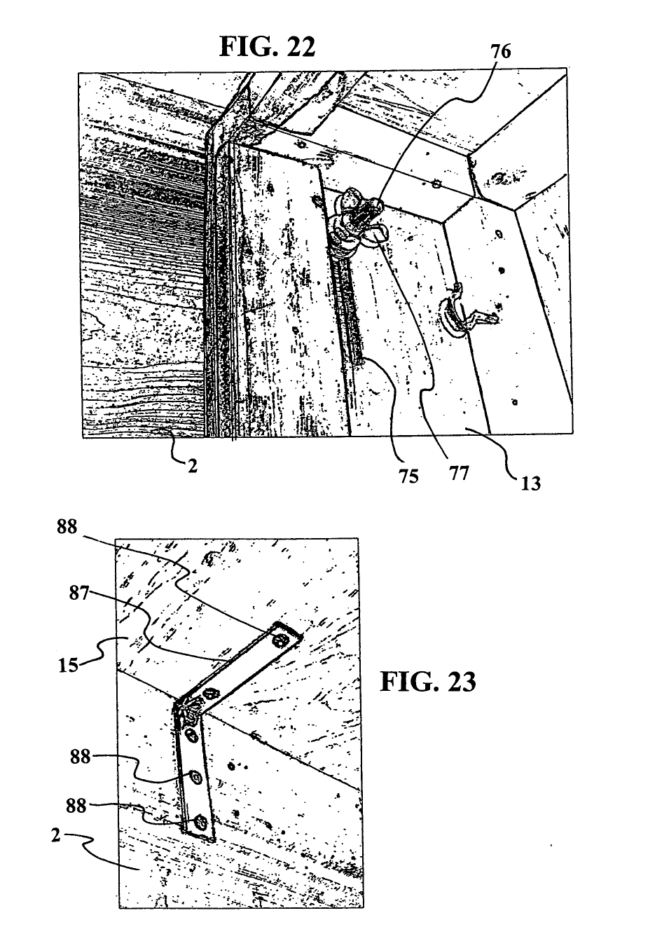

FIG. 23 is a perspective view of a locking bracket 87 used as an alternative structure for securing a vault body 10 to a joist 2. In this example, a bottom 15 of vault body 10 is secured to a joist 2 by wood screws 88, or other suitable fasteners, inserted through holes in bracket 87. In the illustrated example, bottom 15 is formed of a wood, so that vault body 10 is concealed as an apparent part of the structure of the residence or other building.

As a result of implementing any of various embodiments of the disclosed vaults and equivalent structures, a simple, safe, lockable hiding place is provided, the vault adapted for being unlocked and swung down from a ceiling for accessing an inside of the vault, and adapted for then being swung back up to the ceiling and locked thereto for safekeeping of the contents of the vault. For example, items such as golf clubs, fishing gear, sporting goods, jewelry, tools, hunting equipment, wine, RC airplanes, hobby items, dangerous items such as chemicals and firearms, etc., and other items may be held in the subject vault to be out of sight and out of reach of children and others. By forming such a vault in a manner that disguises the vault as an integral part of the resident dwelling, such as by forming the vault body out of HVAC ductwork type sheetmetal, a child or burglar might never suspect that a vault is contained therein. By further implementing embodiments that utilize the joists or studs of a resident dwelling as part of the locking structure, such locking structure may also be disguised as part of a utility system of the building, smoke alarm, electrical box, or similar item that would appear to be unrelated to a safe or vault.

When a vault of the invention is mounted in a ceiling, it may be formed, for example, as a rectangular box made to fit between the floor joists or ceiling rafters or studs. The vault may be made of aluminum, steel, plastic, or any suitable material, and has at least four sides and an underneath (when in an up position) surface. The vault is attached to the joist or ceiling by steel pivot members or bolts. Such pivot portion allow the vault to be swung down from a ceiling, or to be swung up to a vertical position when mounted, for example, between wall studs. The pivot portion may be independent of the vault body, or may include a hinge structure (not shown) attached to a portion of the vault body adjacent its pivoting end. The vault may have a plurality of slide channels or flanges on its top and bottom sides (e.g., relative to a vault up position when mounted to a ceiling); such channels or flanges (shown in the above examples as including a pivoting end of the vault body, a first top flange, and stop bolts that limit an amount of sliding travel of the vault body) assist the locking and pivoting of the vault and its locking mechanism. The vault's locking mechanism is enhanced by structure that stops such sliding of the vault by assisting in prevent the vault from becoming unlocked. Examples of mechanisms, some of which are described herein, that may be used for preventing the vault from sliding include a push button locking enclosure having a recessed pin whose access is prevented by a door having a secret code mechanism. Such pin inserts through the enclosure, through the joist, and through the sidewall of the vault body, thereby keeping the vault from sliding and unlocking. Another such example is a key operated slide in or bolt that attaches to a vault's locking end. Such pin slides through a hole in the joist or locking bracket attached to the ceiling, thereby keeping the vault from sliding and unlocking. Another such example, is a padlock hasp attached to the locking end of the vault, the hasp having a mechanism that slides and padlocks a slide member through a hole in the joist or locking bracket attached to the ceiling. Another such example is a dial combination locking mechanism type enclosure that uses a secretly coded combination type locking door similar to the push button mechanism. Another such example is a combination type lock operated slide pin or bolt similar to the dial or radial type locks found on well-known luggage, where such is adapted to lock a slide pin or bolt in a manner similar to that described for the key locking bolt mechanism, where the locking pin slides into a hole in the joist or into a metal bracket attached to the joist or ceiling. Another such example is any suitable combination of any of the mechanisms or the like. As noted above, a vault body may have a hinge connected thereto, or such hinge may be independently attached to the joists or to the ceiling. Similarly, a locking mechanism may be implemented to lock the vault to the ceiling rather than to one or more joists. Although preferred embodiments have been described for vaults made of metal, a vault may also be formed using at least some plastic. For example, a vault body may be a molded box having slots and horizontal channels molded into the sides of such box, such slots and channels corresponding to pivot bosses or bolts described above for sliding and/or pivoting of the vault. In fact, any suitable material may be used for any part(s) of the vault, depending on the particular application and installation. In another example, a vault or box may have parallel side rails or flanges that accept tension rails adapted to help sort, hold, support, divide, or keep from falling part or all of the items being stored and kept safe while disposed in the vault. The interior of the vault may be customized to cushion or securely hold specific items or groups of items.

An example of an installation of an overhead vault is now provided. Tools required for installing a vault in a typical basement or garage ceiling include an electric drill, metal and wood drill bits (e.g., ⅛, ¼, 9/32, ⅜ inch), a phillips screwdriver, a tape measure, a carpenter's square, a small square (e.g., 12 inch), and a wrench and socket (e.g., 9/16 inch). Safety glasses should always be used when working with tools, especially when working overhead where there is an increased risk of foreign debris entering the eyes. A vault location should be chosen where there are no exposed nails or where any such nails may be broken off. The location should be between a pair of joists with a space therebetween slightly greater than the width of the vault body. For example, a typical spacing between joists is 14.25 to 14.75 inches. A typical height of exposed rafters below a ceiling or upper floorboard is between eight and ten inches, although vaults with a smaller height may be used for joist heights of four to eight inches. Smaller heights may not be practical. The dimension between a pivot axis at the locking end and a locking axis (e.g., locking pin) should be approximately four inches less than the total vault body length. In addition, a clearance from an installed vault to adjacent lengthwise external objects should be approximately four inches from the locking end of the vault and approximately nine to ten inches behind the pivoting end of the vault body. Such will allow the vault body to be slid either in a vertical or horizontal position, depending on a particular application.

According to the general preparation just described, an installer first marks the bottom rafter or joist where the locking end of the vault is intended to be placed. Then four inches towards the pivoting end is marked (“second mark”), then an additional forty-four inches is marked (“third mark”), then an additional ten inches is marked, all along the same joist. The small square is then used to create a line for each of the second and third marks, as respective perpendiculars from the bottom of the joist to its top. Using the large square, as a guide, the installer then transfers the marks to the adjacent joist, checking for accuracy in both directions. Square and plumb vertical lines are then drawn for the second and third marks on the second joist using the small square, as for those on the first joist. The installer then centers one of the bolt plates with its mounting holes facing down, and installs the plate with the large bolt hole centered on the second line and the top of the bolt plate held snugly against the top of the joist (against the ceiling). The plate is mounted to the joist by marking the holes with a sharp pencil, drilling a one inch deep hole in the three plate mounting hole locations using an eighth-inch drill bit, and then screwing the plate on using one and one-quarter inch drywall type screws. The installer then drills a one-quarter inch hole at the center of the large bolt hole of the plate, one and one-quarter inches deep. The installer then repeats the bolt plate installation procedure three additional times for the second and third lines of both joists. For each of the two opposed pivot locations, and for each of two locking side support locations, the installer then places a lag bolt through a bolt standoff and then screws the lag bolt through the large bolt hole in the bolt plate and into the joist until the bolt head is flush with and tensioned against the respective bolt standoff. The bolt plates are now attached to opposing positions, two on each joist.

An exemplary method of installing an overhead vault locking mechanism is now described. As noted above, it is preferred that first top flange 16 have a longer length along the longitudinal axis of vault body 10 compared with second top flange 17. For example, first top flange may extend four inches and second top flange 17 may extend three inches. Such allows vault body 10 to be released at its locking end as it is slid horizontally, allowing vault body 10 to then be lowered using first top flange 16 as a pivot and support member for hanging vault body 10 therefrom. After the installer has determined which direction he wants vault body 10 to swing down, and has chosen which pair of opposed bolt standoffs 35 are to be at a pivoting end 11, the installer lifts vault body 10 and slips first top hanger 16 over that set of bolt standoffs 35. Vault body 10 is then allowed to hang down while the installer installs stop bolts 21 into holes located near each lateral end of first top flange 16 and then secures the two stop bolts 21 with locknuts and washers (not shown). For example, stop bolts 21 may be standard quarter-inch bolts. In addition, stop bolts may be installed through respective ferrules or similar standoffs (not shown) in order to provide a stop surface to prevent bolt standoffs 35 from directly abutting stop bolts 21, thereby protecting any exposed threads of stop bolts 21. For example, such ferrules may comprise ⅜ by ⅞ inch tubes or the like. The installer then carefully lifts locking end 12 and then slips second top flange 17 over the second pair of bolt standoffs 35 mounted to the joists 2. The installer then horizontally slides the suspended vault body 10 back to a locking position.

With vault body 10 at the locking position, the installer then, for example, mounts an end lock 40 such as locking hasp 81 to locking end 12. Alternatively, end lock 40 is already installed on vault body 10 prior to its installation. In either case, for this example, with slide pin 82 all the way retracted, the distal end of pin 82 should be flush with or slightly inward of the right side 14 of vault body 10. With vault body 10 in its up position and pushed towards pivoting end 11 until the pivoting end bolt standoffs 35 abut respective ones of stop bolts 21 or their protective ferrules (“locking position”), the installer slides pin 82 to abut the adjacent joist 2 and then marks the exact location on joist 2 where pin 82 hits. The installer then lowers vault body 10 to its hanging position and drills a hole in joist 2 for receiving pin 82. Then the installer returns vault body 10 to its up and locking position and slides pin 82 into the newly formed hole in joist 2 to assure a correct fit. The same general procedure may be used for installing any other form of end lock 40. When installing a side lock 50, the installer may use a template, marking chalk, or other known methods for accurately locating the center of the point on the target joist 2 where the hole in the side of vault body 10 (e.g., for receiving bolt 54, 56) is located in the locking position. Alternatively, such a hole may be pre-drilled in the joist 2 prior to installing vault body 10, so that for example a hole may be marked and then drilled in left side 13 using the joist hole for accurate positioning. In such a case, a support plate may then be attached to the inner wall of left side 13 to provide a suitable receptacle for bolt 54, 56 in vault body 10.

As a result of implementing the locking vault, a concealed and safe vault may be constructed of wood or metal, may be installed without a need for attaching separate tracks, may be implemented without bearings or rollers attached to the vault, may be implemented without a hinged door or without a sliding guardrail system, may be implemented using the ceiling or joists as part of the locking system, may be adapted for storage of virtually any items, may be concealed without a need for a drop ceiling, may be provided in an easy-to-install kit form, may be implemented with a unique locking system that assures the vault does not slide, which might cause unwanted unlocking and lowering, may be installed to hang in a convenient and accessible vertical loading position, may be installed on a flat ceiling having no ceiling joists, is secure yet easily removable, is adaptable for convenient counter-balancing, may have any of various configurations of locking mechanism, and may also be implemented using a remote control locking mechanism. While secret cabinets, safes, and the like have been used for securely storing firearms, jewelry, and other dangerous and/or valued items, the various advantages of the present invention constitute over prior systems and their installations.

While the principles of the invention have been shown and described in connection with specific embodiments, it is to be understood that such embodiments are by way of example and are not limiting. Consequently, variations and modifications commensurate with the above teachings, and with the skill and knowledge of the relevant art, are within the scope of the present invention. The embodiments described herein are intended to illustrate best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A locking vault adapted to be installed adjacent to at least one housing joist having a longitudinal axis, comprising:
a pivot having a longitudinal axis essentially orthogonal with respect to the longitudinal axis of the housing joist;
a first box adapted to swing, between an open position and a locked position, about the pivot at a pivoting end thereof, the first box having two lengthwise sides and two opposite lengthwise ends that consist of the pivoting end and a locking end; and
a lock disposed proximate the locking end and having an extendable locking pin dimensioned to extend at least from one of the lengthwise sides through the housing joist.

2. The locking vault of claim 1, wherein the lock comprises a spring-loaded mechanism adapted for urging the extendable locking pin toward a retracted position.

3. The locking vault of claim 1, wherein the lock comprises a spring-loaded mechanism adapted for urging the extendable locking pin toward an extended position.

4. The locking vault of claim 1, wherein the lock includes a key-operated mechanism operative to allow/prevent movement of the locking pin from an extended position.

5. The locking vault of claim 1, wherein the lock includes a key-operated mechanism operative to urge the locking pin to/from an extended position.

6. The locking vault of claim 1, further comprising a pin receptacle adapted for receiving a distal end of the locking pin when the locking pin is at an extended position, and adapted for being mounted and positioned on a side of the joist opposite a box-adjacent side of the joist.

7. The locking vault of claim 6, wherein the pin receptacle includes a cover adapted for concealing the distal end of the locking pin at the extended position.

8. The locking vault of claim 6, wherein the pin receptacle includes a base and a cover attachable to the base, the base having a hole larger than a diameter of the locking pin for receiving the locking pin in an extended position, the cover being adapted for concealing the locking pin when the cover is attached to the base.

9. The locking vault of claim 8, the pin receptacle includes a cover locking mechanism adapted for locking the cover to the base.

10. The locking vault of claim 9, wherein the cover locking mechanism includes a code-receiving member adapted for enabling removal of the cover from the base only when a particular code is entered into the code-receiving member.

11. The locking vault of claim 10, wherein the code-receiving member includes a combination dial lock.

12. The locking vault of claim 10, wherein the code-receiving member includes an array of buttons, the code-receiving member being adapted for recognizing a sequence of pushed ones of the buttons and effecting the enabling when such sequence corresponds to the particular code.

13. The locking vault of claim 6, wherein the pin receptacle includes a holding pin, and wherein the locking pin has a hole essentially orthogonal to a longitudinal axis of the locking pin and dimensioned to receive the holding pin for preventing retraction of the locking pin from the pin receptacle.

14. The locking vault of claim 6, wherein the pin receptacle includes a locking member adapted for preventing retraction of the locking pin from an extended position.

15. The locking vault of claim 1 adapted to be installed between a pair of housing joists, wherein the pivot is fixed and includes a rod extending from each of the two lengthwise sides and dimensioned to extend through each joist of the pair of housing joists.

16. The locking vault of claim 1, further comprising an inner box disposed within the first box.

17. The locking vault of claim 16, wherein the inner box has an inner box locking door.

18. The locking vault of claim 16, wherein the inner box is secured to the first box.

19. The locking vault of claim 16, wherein the inner box is adapted to be secured to a housing structure independent of the first box.

20. The locking vault of claim 1, wherein the first box is formed of a metal HVAC duct material.

21. The locking vault of claim 1, wherein the pivot is structured for being secured to a pair of adjacent ceiling joists.

22. The locking vault of claim 21, wherein the first box is dimensioned so that the first box does not protrude below the ceiling joists when at the locked position.

23. The locking vault of claim 21, wherein the pivot is structurally independent of the first box.

24. A method of installing a locking vault in a building having at least one housing joist with a longitudinal axis, the method comprising:
providing a pivot having a longitudinal axis essentially orthogonal with respect to the longitudinal axis of the housing joist;
providing a box adapted to swing, between an open position and a locked position, about the pivot at a pivoting end thereof, the box having two lengthwise sides and two opposite lengthwise ends that consist of the pivoting end and a locking end; and
providing a lock disposed at the locking end and having an extendable locking pin dimensioned to extend at least from one of the lengthwise sides through the housing joist.

25. The method of claim 24, further comprising drilling a hole in the housing joist at a position allowing extension of the locking pin through the hole when the box is in the locked position.

26. The method of claim 24 for installation of the locking vault between a pair of adjacent ceiling joists, wherein the step of providing a pivot includes mounting the pivot through the pair of joists.

27. A method of securing items in a vault adjacent at least one joist having a longitudinal axis, comprising:
providing a pivot having a longitudinal axis essentially orthogonal with respect to the longitudinal axis of the housing joist;
providing a vault box adapted to swing, between an open position and a locked position, about the pivot;
providing a lock disposed proximate the locking end and having an extendable locking pin dimensioned to extend at least from one of the lengthwise sides through the housing joist; and
drilling a hole in the housing joist for receiving the locking pin.
